(19) United States
(12) Patent Application Publication
(10) Pub. No.: US 2026/0270357 A1
(43) Pub. Date: Sep. 10, 2026

(54) IMAGE FORMING APPARATUS, INFORMATION PROCESSING METHOD, AND NON-TRANSITORY RECORDING MEDIUM

(71) Applicant: Takashi MIYAOKA, Tokyo (JP)

(72) Inventor: Takashi MIYAOKA, Tokyo (JP)

(21) Appl. No.: 19/543,913

(22) Filed: Feb. 19, 2026

(30) Foreign Application Priority Data
Mar. 10, 2025 (JP) 2025-037525

(51) Int. Cl. H04N 1/00

(52) U.S. Cl. CPC H04N 1/00928

(57) ABSTRACT

An image forming apparatus includes circuitry to determine a startup mode of an operation device, store the determined startup mode in a memory, and determine whether a predetermined process is executable in the operation device according to the stored startup mode.

### CROSS-REFERENCE TO RELATED APPLICATION

This patent application is based on and claims priority pursuant to 35 U.S.C. § 119(a) to Japanese Patent Application No. 2025-037525, filed on Mar. 10, 2025, in the Japan Patent Office, the entire disclosure of which is hereby incorporated by reference herein.

### BACKGROUND

### Technical Field

The present disclosure relates to an image forming apparatus, an information processing method, and a non-transitory recording medium.

### Related Art

In the related art, some image forming apparatuses are provided with an operating system (OS) in the operation unit that is separate from and independent of an OS of the apparatus main body, thereby enabling various applications to be executed on the operation unit.

For example, in order to efficiently perform synchronization processing of a priority application (an application designed to be displayed on a display unit with priority over other applications) between an operation unit and a main body unit, a structure is proposed in which activation of an application in the operation unit is controlled in accordance with the state of the image forming apparatus.

### SUMMARY

The present disclosure described herein provides an image forming apparatus including circuitry to determine a startup mode of an operation device, store the determined startup mode in a memory, and determine whether a predetermined process is executable in the operation device according to the stored startup mode.

The present disclosure described herein provides an information processing method including determining a startup mode of an operation device of an image forming apparatus, storing the determined startup mode in a memory, and determining whether a predetermined process is executable in the operation device according to the stored startup mode.

The present disclosure described herein provides a non-transitory recording medium storing a plurality of instructions which, when executed by one or more processors, causes the one or more processors to perform an information processing method including determining a startup mode of an operation device, storing the startup mode determined by the determining, and determining whether a predetermined process in the operation device is executable according to the startup mode stored in the storing.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a hardware configuration of a multifunction peripheral (MFP) according to a first embodiment;

FIG. 2 is a diagram illustrating a functional configuration of an MFP according to a first embodiment;

FIG. 3A and FIG. 3B are tables illustrating a termination mode selected when power of an MFP is turned off;

FIG. 4 is a diagram illustrating association between an application of a main device and an application of an operation device;

FIG. 5 is a table illustrating a relationship between a startup mode and information indicating whether a predetermined process is executable;

FIG. 6 is a flowchart of a process performed by an operation device according to a first embodiment;

FIG. 7 is a table illustrating another relationship between a startup mode and information indicating whether a predetermined process is executable;

FIG. 8 is a diagram illustrating a selection screen for selecting a startup mode;

FIG. 9 is a flowchart of another process performed by an operation device according to a modification of the first embodiment;

FIG. 10 is a diagram illustrating a functional configuration of an MFP according to a second embodiment;

FIG. 11 is a table illustrating another relationship between a startup mode and information indicating whether a predetermined process is executable; and

FIG. 12 is a flowchart of a process performed by an operation device according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

A description is given below of an image forming apparatus, an information processing method, and a non-transitory recording medium storing program codes according to the present disclosure, with reference to the accompanying drawings. A multifunction peripheral (MFP) is described below as an example according to the present disclosure, but the present disclosure is not limited to the example. Note that the MFP is an apparatus having at least two functions among a copier function, a scanner function, a facsimile (FAX) communication function, and a printer function.

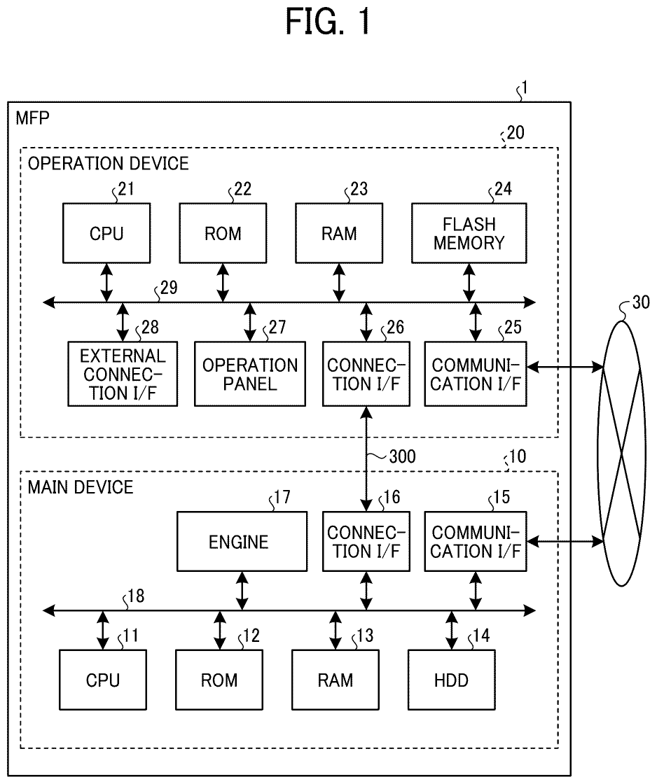

FIG. 1 is a diagram illustrating a hardware configuration of an MFP 1 according to a first embodiment.

The MFP 1 includes a main device 10 and an operation device 20. For example, the main device 10, which corresponds to a body of the MFP 1, implements various functions such as a copier function, a scanner function, a facsimile communication function, and a printer function. The operation device 20 implements functions such as a user interface (UI) for receiving inputs in accordance with user operations.

The operation device 20 includes an operation panel 27 that displays screens and receives user operations. The main device 10 operates in accordance with operations received by the operation device 20. The term “receiving a user operation” refers to a concept that includes receiving information input in accordance with a user operation (including, for example, a signal indicating coordinate values on a screen).

The main device 10 and the operation device 20 are communicably connected to each other via a dedicated communication line 300. The communication line 300 may be in compliance with a universal serial bus (USB) standard. However, any suitable standard, regardless of wired or wireless, may be used as the communication line 300.

The main device 10 operates according to an operation received by the operation device 20.

Further, the main device 10 may communicate with an external device to operate according to an instruction received from the external device.

A hardware configuration of the main device 10 is described below. Referring to FIG. 1, the main device 10 includes a CPU 11, a read-only memory (ROM) 12, a random-access memory (RAM) 13, a hard disk drive (HDD) 14, a communication interface (I/F) 15, a connection I/F 16, and an engine 17, which are connected with one another via a system bus 18.

The CPU 11 controls the overall operation of the main device 10. The CPU 11 controls the operations of the main device 10 and implements various functions such as the above-described copier function, scanner function, facsimile communication function, and printer function by executing a program stored in, for example, the ROM 12 or the HDD 14, using the RAM 13 as a work area.

The communication I/F 15 is an interface for connecting the main device 10 to the network 30. The communication I/F 15 is connected to the network 30 so that the main device 10 can receive printer data from the external device such as a personal computer (PC).

The connection I/F 16 is an interface for communicating with the operation device 20 via the communication line 300.

The engine 17 is hardware that performs dedicated processing for implementing the copier function, the scanner function, the facsimile communication function, and the printer function.

For example, the engine 17 includes a scanner (image reading unit) that scans and reads an image of a document, a printer (image forming unit) that prints an image on a sheet material such as paper, and a facsimile that performs facsimile communication. Furthermore, the apparatus may be provided with specific options such as a finisher that sorts printed sheet materials, or an automatic document feeder (ADF) for automatically feeding documents.

The hardware configuration of the operation device 20 is described below. As illustrated in FIG. 1, the operation device 20 includes a CPU 21, a ROM 22, a RAM 23, a flash memory 24, a communication I/F 25, a connection I/F 26, an operation panel 27, and an external connection I/F 28, which are connected with one another via a system bus 29.

The CPU 21 controls the overall operation of the operation device 20. The CPU 21 controls the operations of the operation device 20 and implements various functions, such as displaying information (images) in accordance with inputs received from a user, by executing a program stored in, for example, the ROM 22 or the flash memory 24, using the RAM 23 as a work area.

The communication I/F 25 is an interface for connecting the operation device 20 to the network 30. The connection I/F 26 is an interface for communicating with the main device 10 via the communication line 300.

The operation panel 27 receives various inputs in accordance with user operations, and displays various types of information (for example, information corresponding to the received inputs, information indicating the operating state of the MFP 1, and information indicating setting states). The operation panel 27 includes a liquid crystal display (LCD) having a touch screen but is not limited to the LCD. For example, the operation panel 27 may include an organic electro luminescence (EL) display device having a touch screen. Furthermore, in addition to or instead of the above-described display, an operation device such as hardware keys and a display unit such as lamps may be provided. The operation panel 27 is not limited to the above-described configuration, as long as the operation panel 27 displays an image and receives an operation corresponding to the image.

The external connection I/F 28 is an interface for connecting the operation device 20 to a peripheral device such as an integrated circuit (IC) card reader.

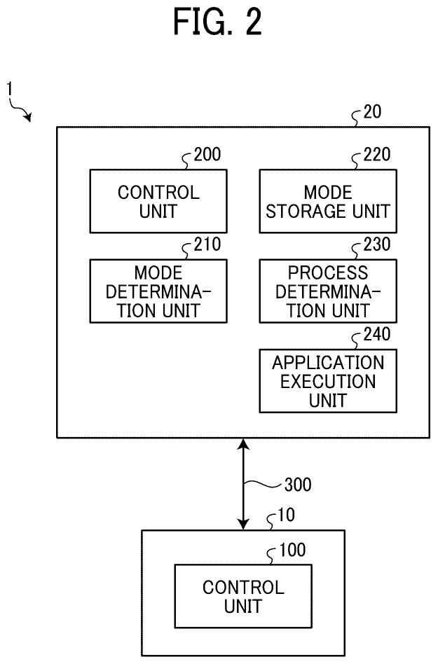

FIG. 2 is a diagram illustrating a functional configuration of the MFP 1 according to the first embodiment. The functions to be executed by the MFP 1 in relation to the present embodiment will be described below.

As illustrated in FIG. 2, the main device 10 includes a control unit 100 that controls the overall operation of the MFP 1. The control unit 100 is implemented by the CPU 11 executing a program. A part of the functions of the control unit 100 may be software (programs) that are loaded onto the RAM 13 by the CPU 11 reading and executing the software (programs) from the ROM 12 or the HDD 14. A part or all of the functions of the control unit 100 may be replaced with hardware circuits such as a circuit that performs arithmetic processing.

A description is given below of the functions of the operation device 20 of the MFP 1. As illustrated in FIG. 2, the operation device 20 includes a control unit 200, a mode determination unit 210, a mode storage unit 220, a process determination unit 230, and an application execution unit 240, which are functions (modules) implemented by the CPU 21 executing a program. A part of the above-described functional elements may be software (programs) loaded onto the RAM 23 by the CPU 21 reading and executing the software (programs) from the ROM 22 or the flash memory 24. A part or all of the above-described units may alternatively be implemented by hardware circuits such as a circuit that performs arithmetic processing.

The control unit 200 controls the overall operation of the operation device 20.

The mode determination unit 210 determines a startup mode of the operation device 20. The startup mode includes, for example, a reset mode, a normal mode, a quick mode, a recovery mode, and an OS update mode. When a power-off operation on the MFP 1 by the user is performed, the mode determination unit 210 determines which of the above-described modes is to be used as a startup mode when the MFP 1 is powered on for the next time.

The reset mode is a mode in which, after the startup, the operation device 20 executes a reset application. The reset application is an application that performs, for example, processes such as returning various settings of the operation device 20 to a factory default state in accordance with a user's selection, and erasing data stored in the operation device 20 by the user. The reset mode is an example of a first mode in which the operation device 20 executes the reset application.

The normal mode is a mode in which the main device 10 starts up after the startup of the operation device 20, and the quick mode is a mode in which the operation device 20 starts up after the startup of the main device 10. When started in the quick mode, functions such as copying and scanning can be quickly used by operating, for example, a start button of the main device 10 before the startup of the operation device 20 is completed. The normal mode and the quick mode are examples of a second mode different from the first mode.

The recovery mode is a restart mode used, for example, after the power button is pressed and the power of the main device 10 has been forcibly turned off. After startup in the recovery mode, the control unit 200 performs a recovery operation of the operation device 20 and executes a restart. The OS update mode is a startup mode during when the OS of the operation device 20 is being updated, and the control unit 200 restarts the operation device 20 after the OS has been updated. The recovery mode and the OS update mode are examples of a third mode in which the operation device 20 restarts within a predetermined period of time. The normal mode and the quick mode are examples of the second mode different from the third mode.

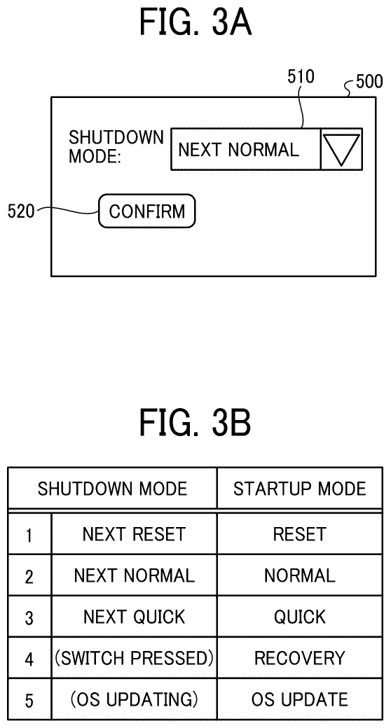

FIG. 3A and FIG. 3B are diagrams illustrating a shutdown mode selected when power of the MFP 1 is turned off.

FIG. 3A illustrates an example of a selection screen 500 displayed on the operation panel 27 when a power-off operation on the MFP 1 is performed. In the example, the selection screen 500 has a shutdown mode selection area 510 and a determination button 520.

FIG. 3B is a diagram illustrating a relationship between the shutdown mode and the startup mode determined by the mode determination unit 210. The shutdown mode 1 is a mode for setting the next startup mode to the reset mode. The shutdown mode 2 is a mode for setting the next startup mode to the normal mode. The shutdown mode 3 is a mode for setting the next startup mode to the quick mode.

The shutdown mode 4 is used, for example, when the power button of the main device 10 is pressed to forcibly shut off the power, and the next startup mode is the recovery mode. The shutdown mode 5 is used when the power is turned off for a restart during updating of the OS, and the next startup mode is the OS update mode.

The user can select the shutdown mode from among the modes (the shutdown modes 1 to 3) by using, for example, a pull-down menu in the shutdown mode selection area 510. The user can press the determination button 520 to turn off the power of the MFP 1 in the selected shutdown mode.

The shutdown modes 4 and 5 are selected not by using the selection screen 500, but as a result of a forced power-off or processing during updating of the OS, as described above.

The mode determination unit 210 determines, for example, in accordance with the relationship illustrated in FIG. 3B, the startup mode to be used at the next power-on by using the shutdown mode selected when a power-off operation on the MFP 1 is performed.

The mode storage unit 220 stores the startup mode determined by the mode determination unit 210. The mode storage unit 220 stores the determined startup mode in, for example, the flash memory 24.

The process determination unit 230 determines whether a predetermined process in the operation device 20 is executable, in accordance with the startup mode stored by the mode storage unit 220. The predetermined process is one or more processes including the startup of an application installed in the operation device 20 (an application of the operation device 20) and a process related to the functions of the application.

The application execution unit 240 starts up the application of the operation device 20 and executes processing related to the functions of the application. The application of the operation device 20 includes application programs (applications), for example, for mail, data input-and-output, copy UI, and scanner UI. These applications of the operation device 20 are associated with applications of the main device 10 (such as a home application, a copy application, and a scanner application), and are executed in conjunction with the execution of the applications of the main device 10 to execute processing. The home application is an application for starting an initial screen that calls up an operation acceptance screen for using the multiple functions of the operation device 20.

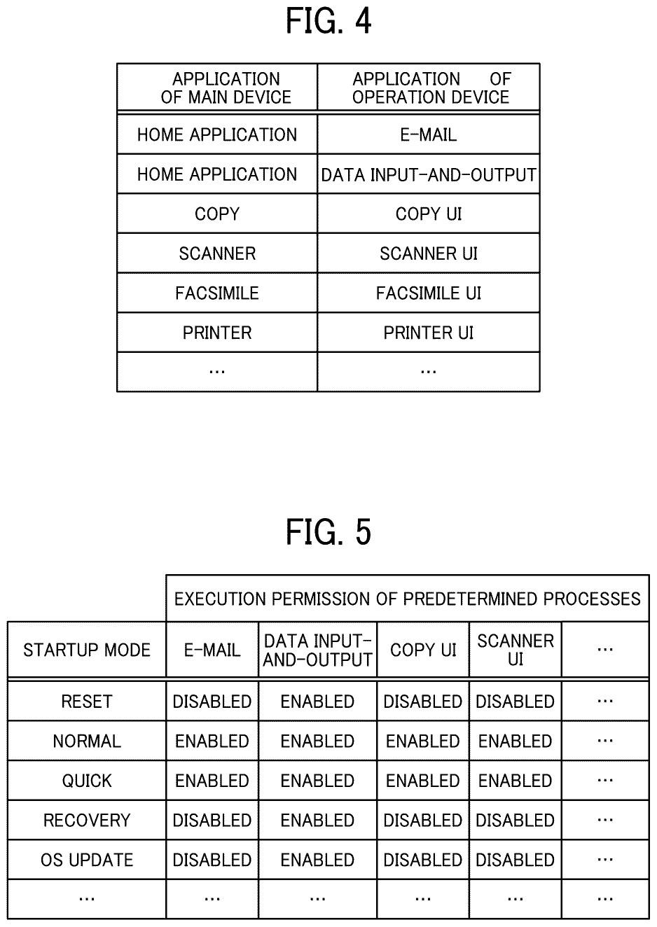

FIG. 4 is a diagram illustrating the association between the application of the main device 10 and the application of the operation device 20. As illustrated in FIG. 4, the home application of the main device 10 is associated with each of the mail application and the data input-and-output application of the operation device 20. In addition, the applications of the main device 10 for the functions of copy, scanner, facsimile, and printer are associated with the UI applications of the operation device 20 corresponding to the respective functions.

FIG. 5 is a diagram illustrating the relationship between the startup mode and information indicating whether a predetermined process is executable. In this example, the information indicating whether the predetermined process is executable includes information indicating whether each application such as the mail application, the data input-and-output application, the copy UI application, and the scanner UI application is to be executed.

When the startup mode is the reset mode, the settings and data of the operation device 20 may be deleted, and therefore, the activation of applications other than those for data input-and-output for selecting the type of reset is not permitted. This prevents unnecessary activation of applications by the operation device 20 (for example, launching of an e-mail application or a copy UI).

When the startup mode is the recovery mode or the OS update mode, since the MFP 1 is highly likely to be restarted within a short period of time, the activation of applications other than those for data input-and-output is not permitted. This prevents interruption of processing via the operation device 20 (such as an e-mail transmission process or a copy mode selection process). The data input-and-output application is executed so as to enable reception of operations required by the user for recovery or OS update.

On the other hand, when the startup mode is the normal mode or the quick mode, since the likelihood that the MFP 1 will be restarted within a short period of time is low, the activation of all applications is permitted. The time until the restart in the case where the startup mode is recovery or OS update is merely an example of a predetermined time.

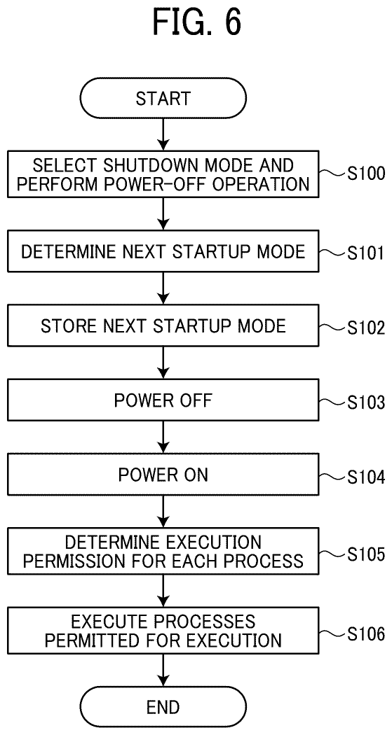

FIG. 6 is a flowchart of a process performed by the operation device 20 according to the first embodiment. In step S100, the MFP 1 receives a user selection of the shutdown mode, which is an example of the power-off operation on the MFP 1. The selection of the shutdown mode is performed via the selection screen 500 displayed on the operation device 20 or by using buttons of the main device 10.

In step S101, the mode determination unit 210 determines the startup mode to be used at the next power-on. In step S102, the mode storage unit 220 stores the determined startup mode in, for example, the flash memory 24.

In step S103, the MFP 1 is powered off. In step S104, the MFP 1 is powered on. In step S105, the process determination unit 230 refers to the stored startup mode to determine whether each process of the operation device 20 is executable. In other words, the process determination unit 230 determines, according to the startup mode, whether each of the applications of the operation device 20 is to be activated. In step S106, the application execution unit 240 executes the process (for example, by executing the application) that has been determined to be executable.

As described above, according to the first embodiment, the MFP 1 determines whether a predetermined process in the operation device 20 is executable, in accordance with the startup mode of the operation device 20. This prevents interruption of processing in the operation device 20 and execution of unnecessary processing in the operation device 20.

### Modification

A description is given below of the MFP 1 according to a modification of the first embodiment. In this modified example, the selection of the startup mode is performed when the MFP 1 is powered on. In the following description of the modification example, descriptions of portions identical or similar to those in the first embodiment are omitted, and only portions different from the first embodiment are described.

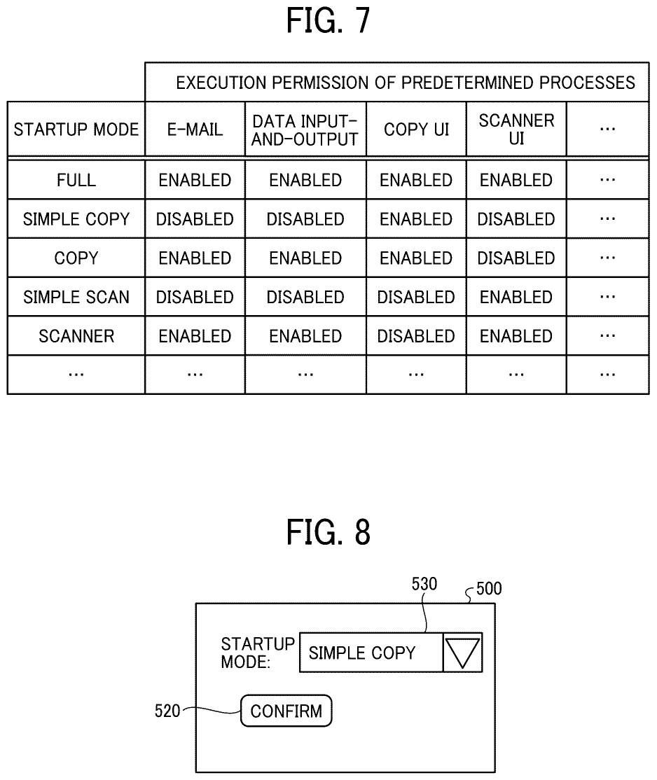

FIG. 7 is a diagram illustrating another relationship between the startup mode and the information indicating whether the predetermined process is executable. The difference between FIG. 7 and FIG. 5 is that the startup mode includes a full mode, a simple copy mode, a copy mode, a simple scanner mode, and a scanner mode.

The full mode is a startup mode in which all functions included in the MFP 1 are activated. Therefore, as illustrated in FIG. 7, the activation of all applications of the operation device 20 is permitted.

When the startup mode is the simple copy mode, only the portion related to copying among the functions included in the MFP 1 is activated. In the simple copy mode, the home application of the main device 10 is not activated. Therefore, as illustrated in FIG. 7, among the applications of the operation device 20, only activation of the copy UI is permitted.

When the startup mode is the copy mode, among the functions included in the MFP 1, the home application of the main device 10 and the portion related to copying are activated. Therefore, as illustrated in FIG. 7, among the applications of the operation device 20, the activation of only the mail application, data input-and-output application, and copy UI application is permitted.

When the startup mode is the simple scanner mode, only the portion related to the scanner among the functions included in the MFP 1 is activated. In the simple scanner mode, the home application of the main device 10 is not activated. Therefore, as illustrated in FIG. 7, among the applications of the operation device 20, the activation of only the scanner Ui application is permitted.

When the startup mode is the scanner mode, among the functions included in the MFP 1, the home application of the main device 10 and the portion related to the scanner are activated. Therefore, as illustrated in FIG. 7, among the applications of the operation device 20, the activation of only the mail application, the data input-and-output application, and the scanner UI application is permitted.

FIG. 8 is a diagram illustrating the selection screen 500 for selecting the startup mode. The selection screen 500 is a screen displayed on the operation panel 27 when the MFP 1 is powered on.

For example, when the user turns on the power button of the main device 10, the selection screen 500 is displayed on the operation panel 27, and the user selects the startup mode and performs the power-on operation.

The difference between FIG. 8 and the selection screen 500 of FIG. 3A is that, in FIG. 8, the selection screen 500 has a startup mode selection area 530 instead of the shutdown mode selection area 510. The user can select the startup mode by using the startup mode selection area 530 when powering on the MFP 1.

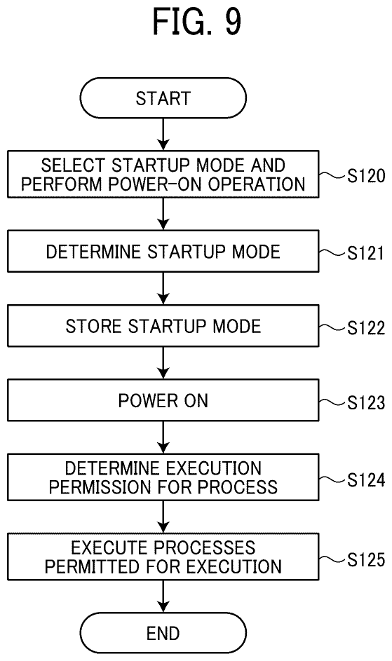

FIG. 9 is a flowchart of another process performed by the operation device 20 according to the modification of the first embodiment. In step S120, the MFP 1 receives a user selection of the startup mode in the startup mode selection area 530, which is an example of the power-on operation.

In step S121, the mode determination unit 210 determines the startup mode based on the selection result indicating the selection from the startup mode selection area 530. In step S122, the mode storage unit 220 stores the determined startup mode in, for example, the flash memory 24.

In step S123, the MFP 1 is powered on. In step S124, the process determination unit 230 refers to the stored startup mode and determines whether each process of the operation device 20 is executable. In other words, the process determination unit 230 determines, according to the startup mode, whether each of the applications of the operation device 20 is to be activated. In step S125, the application execution unit 240 executes the process (for example, by executing the application) determined to be executable.

As described above, according to the first embodiment, the MFP 1 determines whether a predetermined process in the operation device 20 is executable, in accordance with the startup mode of the operation device 20. This prevents interruption of processing in the operation device 20 and execution of unnecessary processing in the operation device 20.

### Second Embodiment

The second embodiment is designed to determine whether deletion of a defective file is executable in accordance with the activation mode. For example, when the operation device 20 is restarted while deletion of a plurality of defective files is in progress, some of the defective files are deleted and the other defective files remain undeleted at the time of restart, which may cause the operation of the operation device 20 to become unstable. In the second embodiment, the above-described problem is avoided by determining whether the deletion of the defective file is executable according to the activation mode. In the following description of the second embodiment, descriptions of elements identical or similar to those in the first embodiment are omitted, and differences from the first embodiment are described.

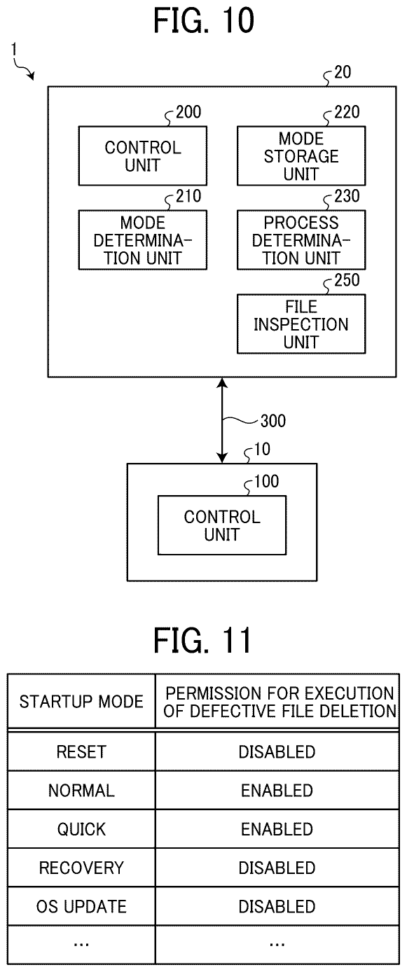

FIG. 10 is a diagram illustrating a functional configuration of the MFP 1 according to the second embodiment. The difference of the MFP 1 between FIG. 10 and FIG. 2 is that the operation device 20 includes a file inspection unit 250 instead of the application execution unit 240.

The file inspection unit 250 inspects files stored in, for example, the flash memory 24 for the presence or absence of defects. In addition, the file inspection unit 250 deletes files in which defects are found (defective files). The process determination unit 230 determines whether deletion of defective files by the file inspection unit 250 is executable in accordance with the startup mode.

FIG. 11 is a table illustrating another relationship between the startup mode and the information indicating whether a predetermined process is executable. The difference between FIG. 11 and FIG. 5 is that the predetermined process is deletion of defective files.

As illustrated in FIG. 11, execution of deletion of defective files is disabled when the startup mode is the reset mode, recovery, or OS update, and is enabled when the startup mode is normal or quick. Accordingly, when there is a possibility that a restart may occur during deletion of defective files, the process of deleting defective files is not executed, thereby avoiding the above-described problem.

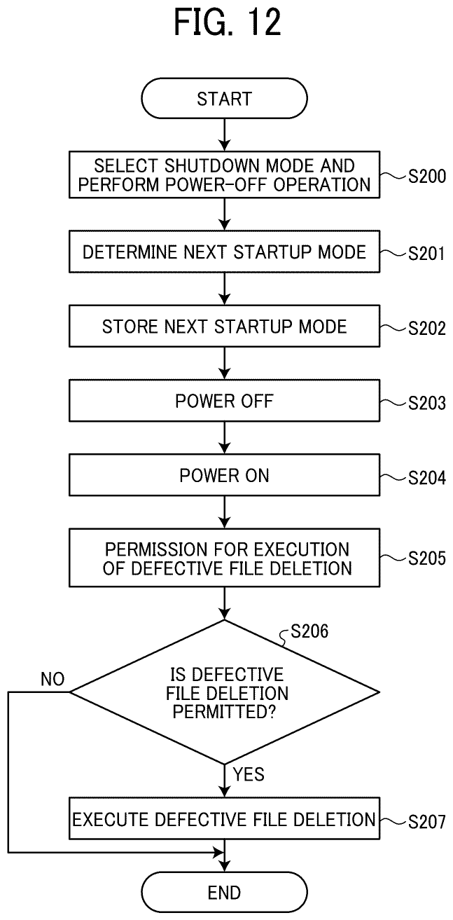

FIG. 12 is a flowchart of a process performed by the operation device 20 according to the second embodiment. The difference between FIG. 12 and FIG. 6 is that the post-restart processing (steps S105 and S106 illustrated in FIG. 6) is replaced by steps S205 to S207 in FIG. 12. Since the process of steps S200 to S204 illustrated in FIG. 12 is the same as the process of steps S100 to S104 illustrated in FIG. 6, the description thereof is omitted.

In step S205, the process determination unit 230 refers to the stored startup mode to determine whether execution of defective file deletion is permitted. In step S206, when deletion of defective files is permitted (Yes), in step S207, the application execution unit 240 executes deletion of the defective files. On the other hand, when deletion of defective files is not permitted (No in step S206), the application execution unit 240 does not execute deletion of the defective files, and the processing is terminated.

The predetermined process executed by the file inspection unit 250 may be a process other than the deletion of the defective file. For example, the predetermined process may be repair of defective files or installation of patch files.

According to the second embodiment, the MFP 1 determines whether deletion of defective files (files having defects) is executable in accordance with the startup mode, thus preventing interruption of the processes being executed in the operation device 20.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the above-described embodiments, the main device 10 and the operation device 20 may operate independently under separate operating systems, or may operate under the same operating system.

The software (program) executed by the MFP 1 in the above-described embodiments may be provided by being recorded, in an installable format file or an executable format file, on a computer-readable recording medium such as a floppy® disk, a compact disc (CD), a CD-recordable (CD-R), a CD read-only memory (CD-ROM), a digital versatile disc (DVD), a secure digital (SD) memory card, or a universal serial bus (USB) memory.

Furthermore, the software (program) executed by the MFP 1 according to the above-described embodiments may be distributed as the software (program) downloaded from a computer connected to a network such as the Internet,. The program executed by the MFP 1 may be provided or distributed via the network such as the Internet.

The configuration in which the main device 10 is connected to the operation device 20 is merely an example, and various system configurations may be employed depending on the application or purpose.

The software (program) executed by the MFP 1 has a module configuration including the above-described functional units. In terms of hardware for implementing the above-described functional units, the CPUs (processors) 11 and 21 read the program from the ROMs 12 and 22 onto the RAMs 13 and 23 for execution, to implement the above functional units. Some or all of the above functional units may be implemented by hardware circuits such as processing circuits that perform arithmetic processing.

An example was given in which the MFP 1 was applied to a multifunction peripheral having at least two functions of a copy function, a printer function, a scanner function, and a facsimile communication function. However, the present disclosure may be applied to any image forming apparatus, such as a copying machine, a printer, a scanner apparatus, or a facsimile apparatus.

Aspects of the present disclosure are as follows.

### Aspect 1

An image forming apparatus includes a mode determination unit that determines a startup mode of an operation unit;
a mode storage unit that stores the startup mode determined by the mode determination unit; and
a process determination unit that determines whether a predetermined process in the operation device is executable according to the startup mode stored in the mode storage unit.

### Aspect 2

In the image forming apparatus according to Aspect 1, the startup mode includes a first mode in which the operation device executes an application for resetting, and a second mode different from the first mode, and
the process determination unit determines that the predetermined process is not executable when the startup mode is the first mode.

### Aspect 3

In the image forming apparatus according to Aspect 1, the startup mode includes a third mode in which the operation device restarts within a predetermined time, and a second mode different from the third mode, and
the process determination unit determines that the predetermined process is not executable when the startup mode is the third mode.

### Aspect 4

In the image forming apparatus according to any one of Aspects 1 to 3, the process determination unit determines, according to the startup mode, whether each of a plurality of applications of the operation device is executable.

### Aspect 5

The image forming apparatus according to any one of Aspects 1 to 4 further includes a file inspection unit that inspects files, and
the process determination unit determines, according to the startup mode, whether deletion of a defective file by the file inspection unit is executable.

### Aspect 6

In the image forming apparatus according to Aspect 5, the startup mode includes a first mode in which the operation device executes an application for resetting, and a second mode different from the first mode, and
the process determination unit determines that, when the startup mode is the first mode, deletion of a defective file by the file inspection unit is not executable.

### Aspect 7

In the image forming apparatus according to Aspect 5, the startup mode includes a third mode in which the operation device restarts within a predetermined time, and a second mode different from the third mode, and
the process determination unit determines that, when the startup mode is the third mode, deletion of a defective file by the file inspection unit is not executable.

### Aspect 8

An information processing method performed by one or more computers includes
determining a startup mode of an operation device;
storing the startup mode determined by the determining; and
determining whether a predetermined process in the operation device is executable according to the startup mode stored in the storing.

### Aspect 9

A program causes one or more computers to perform an information processing method including
determining a startup mode of an operation device;
storing the startup mode determined by the determining; and
determining whether a predetermined process in the operation device is executable according to the startup mode stored in the storing.

In the related art, whether a predetermined process in an operation device is executable in accordance with an activation mode of the operation device is not determined. Therefore, there have been problems in that execution of the process in the operation device may be interrupted, or the operation device may execute unnecessary processes.

According to the present disclosure, it is performed to determine whether a predetermined process in the operation device is executable in accordance with the startup mode of the operation device, thereby providing the advantageous effect described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising circuitry configured to:
determine a startup mode of an operation device;
store the determined startup mode in a memory; and
determine whether a predetermined process is executable in the operation device according to the stored startup mode.

2. The image forming apparatus according to claim 1,
wherein the startup mode includes a first mode in which the operation device executes an application for resetting, and a second mode different from the first mode, and
wherein the circuitry determines that the predetermined process is not executable when the startup mode is the first mode.

3. The image forming apparatus according to claim 1,
wherein the startup mode includes a third mode in which the operation device restarts within a predetermined time period, and a second mode different from the third mode, and
wherein the circuitry determines that the predetermined process is not executable when the startup mode is the third mode.

4. The image forming apparatus according to claim 1,
wherein the circuitry determines, according to the startup mode, whether each of a plurality of applications of the operation device is executable.

5. The image forming apparatus according to claim 1, wherein the circuitry is further configured to
inspect one or more files to identify a defective file, and
determine, according to the startup mode, whether deletion of the defective file is executable.

6. The image forming apparatus according to claim 5,
wherein the startup mode includes a first mode in which the operation device executes an application for resetting, and a second mode different from the first mode, and
wherein the circuitry determines that deletion of the defective file is not executable when the startup mode is the first mode.

7. The image forming apparatus according to claim 5,
wherein the startup mode includes a third mode in which the operation device restarts within a predetermined time period, and a second mode different from the third mode, and
wherein the circuitry determines that deletion of the defective file is not executable when the startup mode is the third mode.

8. An information processing method comprising:
determining a startup mode of an operation device of an image forming apparatus;
storing the determined startup mode in a memory; and
determining whether a predetermined process is executable in the operation device according to the stored startup mode.

9. A non-transitory recording medium storing a plurality of instructions which,
when executed by one or more processors, causes the one or more processors to perform an information processing method comprising:
determining a startup mode of an operation device;
storing the startup mode determined by the determining; and
determining whether a predetermined process in the operation device is executable according to the startup mode stored in the storing.
